(19) United States
(12) Patent Application Publication
(10) Pub. No.: US 2012/0277359 A1
(43) Pub. Date: Nov. 1, 2012

(54) TIRE COMPONENT NOT IN CONTACT WITH AIR, BASED ON NATURAL RUBBER, A REINFORCING FILLER AND A DIHYDRAZIDE

(75) Inventors: Julien Thuilliez, La Roche-Blanche (FR); Stephanie De Landtsheer, Moscow (RU); Brigitte Chauvin, Chamalieres (FR)

(73) Assignees: Michelin Recherche et Technique S.A., Granges-Paccot (CH); Societe De Technologie Michelin, Clermont-Ferrand (FR)

(21) Appl. No.: 13/138,036

(22) PCT Filed: Dec. 22, 2009
(86) PCT No.: PCT/EP2009/067750

§ 371 Date: Jul. 20, 2012

(30) Foreign Application Priority Data
Dec. 23, 2008 (FR) 0858991

(51) Int. Cl. C08L 7/00; C08K 5/25; B29C 67/24; B29C 47/00; B60C 1/00; B60C 9/02

(52) U.S. Cl. 524/192; 152/451; 152/548; 264/175; 264/176.1

(57) ABSTRACT

Tire component which is not in contact with air or with an inflation gas, comprising a rubber composition based on (a) an elastomeric matrix based on natural rubber, (b) a reinforcing filler, (c) from more than 2.5 to 8.5 phr of sulphur and (d) a dihydrazide compound corresponding to the following formula:

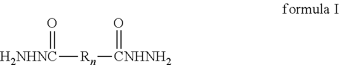

in which R is a divalent hydrocarbon radical chosen from substituted or unsubstituted aromatic radicals having 6 to 20 carbon atoms, linear or branched, saturated or unsaturated, aliphatic radicals having 2 to 20 carbon atoms, and n is equal to 0 or 1. These tire components are more particularly those which comprise thread-like reinforcing elements, more especially metallic thread-like reinforcing elements, such as the carcass or crown plies of the tire.

The present invention relates to tire components that are not in contact with air or with an inflation gas, especially those that comprise thread reinforcing elements, and more particularly to the composition thereof.

The tire for a motor vehicle comprises, among its constituents, metallic or textile reinforcing or strengthening elements, generally in the form of thread(s) or assemblies of to threads, coated in specific, sulphur-crosslinkable rubber compositions. These composite combinations of reinforcements and of rubber composition, also referred to in a simplified manner as “reinforcement/rubber composites”, make up, for example, the carcass ply or else the crown plies of the tire.

The rubber composition of these composites, also referred to as calendering compound, must meet, in a known manner, a large number of often conflicting technical requirements, including a requirement of sufficient stiffness while maintaining good cohesion of the compound, and also a requirement of tack ensuring good adhesion of the composition to the reinforcing element. The combined improvement of these opposing properties such as stiffness and adhesion, remains a constant concern of tire designers, one generally being obtained to the detriment of the other in particular for compositions in contact with metallic reinforcements.

Indeed, in metallic reinforcements/rubber composites, it may in particular be recalled that the conventional process for binding the rubber compositions to the steel that constitutes the reinforcements, consists in coating the surface of the steel with brass (copper-zinc alloy), the bonding between the steel and the rubber composition being provided by sulphidation of the brass during the vulcanization. This consumption of sulphur to the detriment of its involvement in the crosslinking of the rubber, leads to a drop in the stiffness of the rubber composition.

To compensate for this drop in the stiffness, it can be envisaged to increase the amount of reinforcing filler in the rubber composition. Unfortunately, experience shows that such a readjustment of the stiffness is accompanied by a significant increase in hysteresis losses of the rubber composition.

To rebalance the proportion of sulphur in the crosslinking reaction, it may then be necessary to adapt the vulcanization system of these particular rubber compositions especially via an activation of the vulcanization. However, increasing the content of vulcanization accelerator, and also the use of an ultra-accelerator, are penalizing, or even poisoning for the sulphidation. Stearic acid also degrades the correct behaviour of the adhesive interface. Therefore, it is preferred to use a vulcanization system that contains only little vulcanization accelerator and little fatty acid or fatty acid ester in order to preserve the level of adhesion. However, such highly altered vulcanization systems do not permit an effective vulcanization and are not without an effect on the properties of the crosslinked rubber compositions, especially on the stiffness which is degraded, and therefore on the hysteresis which is substantially increased.

Subjected to very high stresses when the tires are running, especially subjected to repeated compressions, bending or variations in curvature, the reinforcement/rubber composites must, in a known manner, satisfy a large number of technical criteria such as uniformity, flexibility, endurance in flexion and in compression, tensile strength and wear resistance, etc. However the solutions stated above have consequences which do not make it possible to maintain these performances at a very high level for as long a time as is desired.

Indeed, the highly unbalanced vulcanization systems of such rubber compositions lead to crosslinking that is not very effective which results in a high hysteresis of the compositions. The generally high levels of stiffness of such compositions required for tire applications only amplifies the high level of hysteresis experienced due to the formulation constraints of said compositions and often penalizes the properties of adhesion of the rubber composition to the reinforcement.

In view of the foregoing, it is a general objective to provide rubber compositions for reinforcement/rubber composites which satisfy a complex compromise of properties that is acceptable for use in tires.

This is why one aim of the present invention is to provide a rubber composition for reinforcement/rubber composites that makes it possible to achieve a satisfactory level of stiffness while maintaining good cohesion of the composition without degrading the tack thereof and while conferring acceptable hysteresis properties.

Following their research, the inventors have discovered that the addition, to a rubber composition that can be used in the reinforcement/rubber composites of tires, of certain compounds of dihydrazide type makes it possible to achieve, unexpectedly, an acceptable comprise of stiffness/adhesion/hysteresis/cohesion properties.

Furthermore, the inventors have also demonstrated that dihydrazide compounds of this type may advantageously be used in mixtures for tire components adjacent to the reinforcement/rubber composites. Indeed, this type of composition is capable of giving rise to a degradation of the tack of the composition in contact with the thread-like reinforcing elements, either via migration of certain ingredients from the layer of rubber adjacent to that of a reinforcement/rubber composite, or else via flow movements during building or during curing which may create local contacts of this layer of rubber with the metallic reinforcement. Thus, it is advisable for these adjacent layers not to contain a poison for the composites while satisfying an acceptable compromise of properties for use in tires. This is the case with the rubber composition according to the invention. Examples of such adjacent layers are the compounds bordering crown plies or carcass plies, the compounds for internal reinforcement of the carcasses, the compounds for filling between the carcass plies and the stiffeners used in the bottom zone, etc.

Thus, one subject of the present invention is a tire component which is not in contact with air or with an inflation gas, characterized in that it comprises a rubber composition comprising (a) an elastomeric matrix based on natural rubber, (b) a reinforcing filler, (c) from more than 2.5 to 8.5 phr of sulphur and (d) a dihydrazide compound corresponding to the following formula:

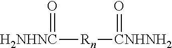

in which R is a divalent hydrocarbon radical chosen from substituted or unsubstituted aromatic radicals having 6 to 20 carbon atoms, linear or branched, saturated or unsaturated, aliphatic radicals having 2 to 20 carbon atoms, and n is equal to 0 or 1.

Another subject of the invention is a process for manufacturing a tire component which is not in contact with air or with an inflation gas as defined above.

Another subject of the invention is a tire in which at least one of the components which is not in contact with air or with an inflation gas is a component as defined above.

In the present description, unless expressly indicated otherwise, all the percentages (%) indicated are % by weight. Moreover, any interval of values denoted by the expression “between a and b” represent the range of values going from more than a to less than b (i.e. the limits a and b excluded) whereas any interval of values denoted by the expression “from a to b” means the range of values going from a to b (i.e. including the strict limits a and b).

One subject of the invention is therefore a tire component that is not in contact with air or with an inflation gas. Therefore, excluded from the tire components according to the invention are the tread, the sidewalls, and the inner layer or inner liner.

According to one variant of the invention, the tire component that is not in contact with air or with an inflation gas is a component that also comprises a thread-like reinforcing element. More particularly, according to this variant, the tire component is a component comprising, besides the rubber composition, a metallic reinforcement. Mention may be made, for example, of crown plies, the carcass ply, and the bead wire and bead wire rubber assembly.

According to another variant of the invention, the tire component that is not in contact with air or with an inflation gas is a rubber composition or layer that is adjacent, in the tire, to components comprising thread-like reinforcing elements.

The rubber composition of the tire component according to the invention comprises at least four compounds, including one dihydrazide compound corresponding to the formula I below:

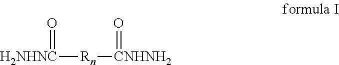

in which R is a divalent hydrocarbon radical chosen from substituted or unsubstituted aromatic radicals having 6 to 20 carbon atoms, linear or branched, saturated or unsaturated, aliphatic radicals having 2 to 20 carbon atoms, and n is equal to 0 or 1.

The dihydrazide compounds are compounds described in the prior art mainly for reducing the self-heating of tread compositions. Mention may be made, for example, of EP 0 478 274 A1. Dihydrazide compounds have also been used in rubber compositions intended for the manufacture of tread, combined with various other compounds. Thus, for example, EP 1 083 199 A1 describes a tread composition comprising a dihydrazide compound in the presence of a bismaleimide in order to attenuate the negative effects of the latter on the properties of the tread composition that contains it. EP 0 761 733 A1 combines isophthalic acid dihydrazide with specific carbon blacks and functionalized SBRs in tread compositions. EP 0738 754 A1 combines isophthalic acid dihydrazide and isonicotinic acid dihydrazide with an isobutylene/para-methylstirene/para-bromomethylstirene copolymer in a tread composition.

In EP 1 199 331 A1, dihydrazide compounds are mentioned, among other hydrazides, as possibly being used in rubber compositions comprising polymaleimides, with a view to reducing thermal runaway. Compositions for treads comprising 3-hydroxy-N′-(1,3-dimethyl butylidene)-2-naphthoic acid hydrazide and SBR as the sole elastomer are illustrated.

In JP 2002146110 A, the compounds of a large family of hydrazides are combined with hexamethylene bis(sodium thiosulphate) dihydrate with a view to improving the crack resistance without penalizing the self-heating properties. More specifically, compositions based on natural rubber comprising, as hydrazides, 3-hydroxy-N′-(1,3-dimethyl butylidene)-2-naphthoic acid hydrazide and 3-hydroxy-2-naphthoic acid hydrazide are illustrated.

According to the present invention, the dihydrazide compounds corresponding to the formula I are preferably chosen from those for which, in the formula I, R is a divalent hydrocarbon radical chosen from unsubstituted aromatic radicals having 6 to 14 carbon atoms, and linear saturated aliphatic radicals having 3 to 12 carbon atoms.

More preferably, these dihydrazide compounds are chosen from phthalic acid dihydrazide, isophthalic acid dihydrazide, terephthalic acid dihydrazide, succinic acid dihydrazide, adipic acid dihydrazide, azelaic acid dihydrazide, sebacic acid dihydrazide, oxalic acid dihydrazide and dodecanoic acid dihydrazide. More preferably still, these dihydrazide compounds are chosen from those represented in the figures below:

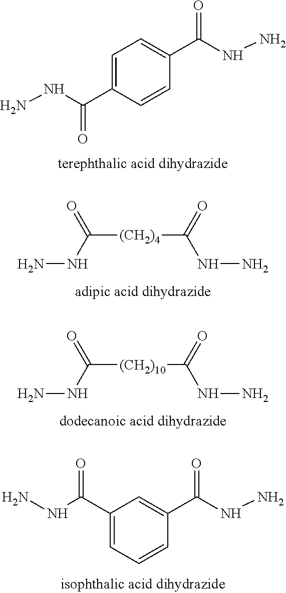

The rubber composition of the tire component according to the invention comprises at least one dihydrazide compound in an amount ranging from 0.25 to 7 phr, preferably from 0.3 to 2 phr.

The rubber composition of the tire component according to the invention comprises at least four compounds, also including an elastomeric matrix.

The rubber compositions constituting the tire components that are not in contact with air or with an inflation gas, and more particularly the rubber compositions that are in contact with the reinforcing elements, are generally based on natural rubber since its property of green tack allows a necessary maintaining of the distances between threads during the formation of the green pneumatic tire.

According to the invention, the elastomeric matrix of the composition is based on natural rubber. In certain cases, the elastomeric matrix may advantageously be entirely constituted of nature rubber (100% of the elastomeric matrix is constituted of natural rubber). This variant is preferably implemented when the tire component is a reinforcement/rubber composite, more particularly a metallic reinforcement/rubber composite.

The elastomeric matrix may also, besides natural rubber, comprise at least one other diene elastomer.

This or these other diene elastomers are then present in the matrix in proportions between 0 and 50% by weight (the limits of this range being excluded), preferably from 5% to 30%.

In the case of a blend with at least one other diene elastomer, the weight fraction of natural rubber in the elastomeric matrix is a majority weight fraction and is preferably greater than 50% by weight of the total weight of the matrix.

The expression “majority weight fraction” according to the invention refers to the highest weight fraction of the blend. Thus, in an NR/elastomer A/elastomer B blend, the weight fractions may be distributed as 40/40/20 or 40/30/30, the majority weight fractions being 40. And in an NR/elastomer blend, the weight fractions may be distributed as 70/30, the majority weight fraction being 70.

The expression “diene elastomer” should be understood according to the invention as any functionalized natural rubber and any synthetic elastomer resulting at least in part from diene monomers. More particularly, the expression “diene elastomer” is understood to mean any homopolymer obtained by polymerization of a conjugated diene monomer having 4 to 12 carbon atoms, or any copolymer obtained by copolymerization of one or more conjugated dienes with each other or with one or more vinylaromatic compounds having from 8 to 20 carbon atoms. In the case of copolymers, these contain from 20% to 99% by weight of diene units, and from 1 to 80% by weight of vinylaromatic units.

The functionalized natural rubber according to the invention is preferably an epoxidized natural rubber (ENR).

The diene elastomer constituting a part of the elastomeric matrix according to the invention is preferably chosen from the group of highly unsaturated diene elastomers formed by polybutadienes (BRs), butadiene copolymers, synthetic polyisoprenes (PIs), isoprene copolymers and blends of these elastomers. Such copolymers are more preferably chosen from the group formed by copolymers of butadiene and of a vinylaromatic monomer, more particularly the butadiene-stirene copolymer (SBR), isoprene-butadiene copolymers (BIRs), copolymers of isoprene and of a vinylaromatic monomer, more particularly the isoprene-stirene copolymer (SIR) and isoprene-butadiene-stirene copolymers (SBIRs). Among these copolymers, the copolymers of butadiene and of a vinylaromatic monomer, more particularly the butadiene-stirene copolymer (SBR), are particularly preferred.

The diene elastomer constituting a part of the elastomeric matrix according to the invention may be star-branched, coupled, functionalized, in a manner known per se, by means of a functionalizing, coupling or star-branching agent known to a person skilled in the art. This agent may be based on tin for example.

Advantageously, the rubber composition according to the invention does not comprise an isobutylene-para-methylstirene-para-bromomethylstirene copolymer. Indeed, in certain inner compound applications, this type of copolymer may create degradations of the interface.

The rubber composition of the tire component according to the invention comprises at least four compounds, also including a reinforcing filler in proportions ranging from 30 to 200 phr. Preferably, the content of total reinforcing filler is between 40 and 130 phr, more preferably between 50 and 120 phr.

Use may be made of any type of reinforcing filler known for its ability to reinforce a rubber composition, for example an organic filler, such as carbon black, a reinforcing inorganic filler, such as silica, or else a blend of these two types of filler, in particular a blend of carbon black and silica. Preferably, according to the invention, the reinforcing filler is predominantly organic, that is to say that it comprises more than 50% by weight of the total weight of the filler, of one or more organic fillers.

All carbon blacks, in particular blacks of the HAF, ISAF, SAF, FF, FEF, GPF and SRF type, conventionally used in rubber compositions for tires (“tire-grade” blacks) are suitable as carbon blacks. Mention will more particularly be made, among the latter, of the reinforcing carbon blacks of the 100 to 600 series (ASTM grades), such as, for example, the N115, N134, N234, N326, N330, N339, N347 or N375 blacks, or the coarser N550 or N683 blacks. The carbon blacks may, for example, already be incorporated in the natural rubber in the form of a masterbatch.

Mention may be made, as examples of organic fillers other than carbon blacks, of the functionalized aromatic vinyl polymer organic fillers as described in Applications WO-A-2006/069792 and WO-A-2006/069793, or else the functionalized non-aromatic vinyl polymer organic fillers as described in Applications WO-A-2008/003434 and WO-A-2008/003435.

The expression “reinforcing inorganic filler” should be understood, in the present patent application, by definition, to mean any inorganic or mineral filler regardless of its colour and its (natural or synthetic) origin, also known as “white filler” in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known manner, by the presence of hydroxyl (—OH) groups at its surface.

Preferably, the reinforcing inorganic filler is, in its entirety or at least predominantly (more than 50% by weight of the total weight of the inorganic filler) silica (SiO₂). The silica used can be any reinforcing silica known to a person skilled in the art, in particular any precipitated or pyrogenic silica exhibiting a BET surface area and a CTAB specific surface area both of less than 450 m²/g, even if highly dispersible precipitated silicas are preferred. Mention will also be made, as reinforcing inorganic filler, of mineral fillers of the aluminous type, in particular alumina (Al₂O₃) or aluminium (oxide) hydroxides, or else reinforcing titanium oxides.

The physical state in which the reinforcing inorganic filler is provided is not important, whether it is in the form of a powder, of micropearls, of granules, of beads or any other appropriate densified form. Of course, the expression “reinforcing inorganic filler” is also understood to mean mixtures of various reinforcing inorganic fillers, in particular of highly dispersible siliceous and/or aluminous fillers known to a person skilled in the art.

When the reinforcing filler comprises an inorganic filler, the proportion of this inorganic filler varies between 0 and 50%, preferably from 5 to 40%, by weight relative to the total weight of the reinforcing filler.

The proportion of organic filler in the reinforcing filler varies from more than 50% to 100%, and is preferably greater than 60%, by weight relative to the total weight of the reinforcing filler.

The rubber composition according to the invention in addition conventionally comprises, when the reinforcing filler comprises an inorganic filler, a reinforcing inorganic filler/elastomer matrix bonding agent.

The expression “bonding agent” is understood more specifically to mean an agent capable of establishing a satisfactory bond of chemical and/or physical nature between the filler under consideration and the elastomer, while facilitating the dispersion of this filler in the elastomer matrix. Such an at least bifunctional bonding agent has, for example, the simplified general formula “Y-T-X′”, in which:
Y represents a functional group (“Y” function) which is capable of being bonded physically and/or chemically to the inorganic filler, it being possible for such a bond to be established, for example, between a silicon atom of the coupling agent and the surface hydroxyl (—OH) groups of the inorganic filler (for example, surface silanols when silica is involved);
X′ represents a functional group (“X′” function) capable of being bonded physically and/or chemically to the elastomer, for example via a sulphur atom;
T represents a divalent group which makes it possible to connect Y and X′.

The bonding agents must not be confused with simple agents for covering the filler under consideration which, in a known way, can comprise the Y function which is active with regard to the filler but are devoid of the X′ function which is active with regard to the elastomer. Use may be made of any bonding agent known for, or capable of efficiently providing, in rubber compositions that can be used for the manufacture of tires, the bonding (or the coupling) between a reinforcing inorganic filler, such as silica, and a diene elastomer, such as, for example, organosilanes, in particular polysulphide-containing alkoxysilanes or mercaptosilanes, or else polyorganosiloxanes bearing the above-mentioned X′ and Y functions. Silica/elastomer bonding agents, in particular, have been described in a large number of documents, the best known being bifunctional alkoxysilanes, such as polysulphide-containing alkoxysilanes.

In the compositions in accordance with the invention, the content of bonding agent is advantageously less than 20 phr, it being understood that it is generally desirable to use the least amount possible thereof. Its content is preferably between 0.5 and 12 phr. The presence of the bonding agent depends on that of the reinforcing inorganic filler. A person skilled in the art will know how to adjust the content of bonding agent necessary as a function of that of the inorganic filler used.

The rubber composition of the tire component according to the invention comprises at least four compounds, also including sulphur or a sulphur-donor compound, the elemental sulphur proportion of which is greater than 2.5 phr and may reach 8.5 phr.

Sulphur is an element which is essential to the vulcanization of the rubber. However, in rubber compositions intended to be brought into contact with thread-like, in particular metallic, reinforcements, a portion of the sulphur is consumed in the formation of an attachment interface between the gum and the metal. Therefore, the sulphur is present in the rubber compositions according to the invention, intended for the preparation of reinforcement/rubber composites or adjacent layers, in proportions greater than those customarily used in compositions for treads for example.

In the rubber composition of the tire component according to the invention, the elemental sulphur is preferably present in proportions ranging from 3.5 to 7 phr.

Besides the sulphur, the rubber composition according to the invention may comprise other ingredients which constitute the crosslinking system. Among these ingredients, mention may be made of vulcanization activators, in particular zinc oxide alone or used with fatty acids or fatty acid esters, such as stearic acid or stearates, and vulcanization accelerators, in particular of sulphenamide type.

Given the specificity of the rubber composition according to the invention, all of the sulphenamide-type accelerators and vulcanization activators are used at a preferred content between 4 and 16 phr, more preferably between 4.5 and 15.5 phr. In particular, the content of sulphenamide-type accelerators is used at a preferred content between 0.4 and 1.2 phr. Furthermore, the content of zinc oxide is preferably within a range being from 4 to 10 phr.

The compositions in accordance with the invention may also comprise, besides the four compounds described above, plasticizers, pigments, antioxidants, anti-fatigue agents, reinforcing or plasticizing resins, for example such as described in document WO 02/10269, peroxides and/or bismaleimides, methylene acceptors (for example, phenol-novolac resin) or methylene donors (for example, HMT or H3M), extender oils, one or more agents for coating the silica such as alkoxysilanes, polyols or amines, and adhesion promoters such as organic salts or complexes of cobalt.

The invention also relates to a process for preparing a tire component that is not in contact with air or with an inflation gas as described previously.

It should be noted that, according to the invention, the dihydrazide compound may be incorporated at any moment into the process for preparing the rubber composition described above, including during the manufacture of the natural rubber at its production site at any step of its manufacture.

According to the invention, the tire components are manufactured in appropriate mixers, using two successive preparation phases, according to a general procedure well known to a person skilled in the art, along with the shaping thereof.

The rubber component in accordance with the invention may thus be prepared according to a process comprising the following stages:
(i) carrying out a first step of thermomechanical working (sometimes described as “non-productive” phase) of the necessary basic constituents of the rubber composition, with the exception of the crosslinking system, by intimate incorporation, via thermomechanical kneading, in one or more stages, into the elastomeric matrix based on natural rubber, of these base ingredients until a maximum temperature of between 130° C. and 200° C., preferably between 145° C. and 185° C. is reached, then
(ii) carrying out, at a temperature below said maximum temperature of said first step, preferably below 120° C., a second step of mechanical working during which said crosslinking system is incorporated,
(iii) extrusion or calendering of the rubber composition thus obtained, in the desired form, in order to manufacture the tire components of the invention.

Thus, in stage (iii), the mixture may be calendered in order to manufacture, for example, crown plies or carcass plies. It may also be extruded in a particular shape, for example specific to a layer, in the tire, adjacent to a crown ply or carcass ply, such as a compound bordering crown plies, a compound for internal reinforcement of the carcasses, etc.

The dihydrazide compounds corresponding to the formula I described above may therefore be incorporated:
either as an additive during the manufacture of the natural rubber at its production site,
or as an ingredient of the rubber composition according to the invention:
   during the prior production of a natural rubber/dihydrazide masterbatch on an open machine of the open mill type or on a closed machine of internal mixer type,
   without prior production of a masterbatch, directly into the mixer during the first non-productive phase with the other compounds of the rubber composition.

This is why, according to one variant of the invention, the process for preparing a tire component comprises, prior to carrying out the aforementioned stage (i), the stages of the conventional manufacture of the natural rubber which comprises the addition of the dihydrazide compound of formula I.

Another variant of the process according to the invention comprises, prior to carrying out the aforementioned stage (i), a stage of preparing a masterbatch based on natural rubber and on the dihydrazide compound of formula I.

Another variant of the process according to the invention comprises the incorporation of the dihydrazide compound of formula I during stage (i).

The adhesion promoter such as, for example, cobalt compounds, when it is present, may be incorporated at various stages of the process for preparing a tire component of the invention. According to a first variant, the adhesion promoter may be incorporated into the elastomeric matrix during the “non-productive” phase of stage (i). According to a second variant, the adhesion promoter may be incorporated into the mixture resulting from stage (i), during stage (ii) with the vulcanization system.

Another subject of the invention is a tire, in which at least one of its components not in contact with air or with an inflation gas is a component as described above, and more particularly a composite component comprising metallic thread-like reinforcing elements, such as the carcass ply or a crown ply.

The invention and also its advantages will be readily understood in light of the following exemplary embodiments.

### Measurements and Tests Used

The rubber compositions are characterized before and after curing, as indicated below, the results are given in relative values, the value 100 being that of the control.

a) The Mooney viscosity ML (1+4) at 100° C.: measured according to the standard ASTM: D-1646, entitled “Mooney” in the tables, an increase in the relative value representing an increase in the Mooney viscosity.
(b) The SHORE A hardness: measurements carried out according to the standard DIN 53505, an increase in the relative value representing an increase in the Shore hardness.
(c) The elongation modulii at 300% (MA 300), at 100% (MA 100) and at 10% (MA 10) and the calculation of the reinforcement index MA300/MA100: measurements carried out according to the standard ISO 37 at 23 and 100° C., an increase in the relative value representing an increase in the modulii.
(d) The dynamic properties Delta G* and tan(δ)ₘₐₓ are measured on a viscoanalyser (Metravib VA4000) according to the standard ASTM D 5992-96. The response of a sample of vulcanized composition (cylindrical test specimen with a thickness of 2 mm and a cross section of 79 mm²), subjected to a sinusoidal stress in simple alternating shear, at a frequency of 10 Hz, under normal temperature conditions (60° C.) according to the standard ASTM D 1349-99. A scan with a peak-to-peak strain amplitude ranging from 0.1 to 50% (forward cycle) then from 50% to 0.1% (return cycle) is carried out. The results gathered are the complex dynamic shear modulus (G*) and the loss factor tan δ. For the return cycle, the maximum value of tan δ observed (tan(δ)ₘₐₓ), and also the difference in the complex modulus (Delta G*) between the values at 0.1 and 50% strain (the Payne effect) are indicated. An increase in the relative value represents an increase in the value measured.
(e) The adhesion test: the quality of the bond between the metallic reinforcement and the rubber matrix is assessed by a test in which the force, known as the tear-out force, needed to extract the metallic reinforcement from the rubber matrix, in the vulcanized state, is measured. The metal/rubber composite used in this test is a block of rubber composition, composed of two sheets having a size of 300 mm (millimetres) by 150 mm and a thickness of 3.5 mm, applied to one another before curing; the thickness of the resulting block is then 7 mm. It is during the building of this block that the reinforcements, for example twelve in total, are trapped between the two uncured sheets; only one given length of reinforcement, for example of 12.5 mm, is left free to come into contact with the rubber composition to which this length of reinforcement will be bonded during the curing; the rest of the length of the reinforcements is isolated from the rubber composition (for example using a plastic or metallic film) in order to prevent any adhesion outside of the given contact zone. Each reinforcement passes through the rubber block on both sides, at least one of its free ends retaining sufficient length (at least 5 cm, for example between 5 and 10 cm) in order to allow the subsequent tensile loading of the reinforcement. The block comprising the twelve reinforcements is then placed in a suitable mould then cured, unless otherwise indicated, for 40 minutes at 150° C., under a pressure of around 11 bar. At the end of the curing and/or of the optional subsequent accelerated ageing, which may be a heat ageing at 135° C. for 16 h or a “wet heat ageing” at 105° C. for 16 h under a relative humidity of 100%, the block is cut into test specimens each containing a reinforcement that is subjected to a tensile load outside of the rubber block using a tensile testing machine; the pull rate is 50 mm/min; the adhesion is characterized by the force necessary to tear out the reinforcement from the test specimen, at a temperature of 20° C.; the tear-out force (denoted Fa) represents the average of the 12 measurements corresponding to the 12 specimens from the initial block. An increase in the relative value represents an increase in the tear-out force measured.

### EXAMPLE 1

### Compositions in Accordance or not in Accordance with the Invention, Comprising One or More Elastomers

Incorporation of the Molecule:

Several molecules of hydrazide type were used as an additive of natural rubber:
terephthalic acid dihydrazide,
adipic acid dihydrazide,
dodecanoic acid dihydrazide,
isophthalic acid dihydrazide,
propionic acid hydrazide,
benzhydrazide.

The molecules are represented in the figures below.

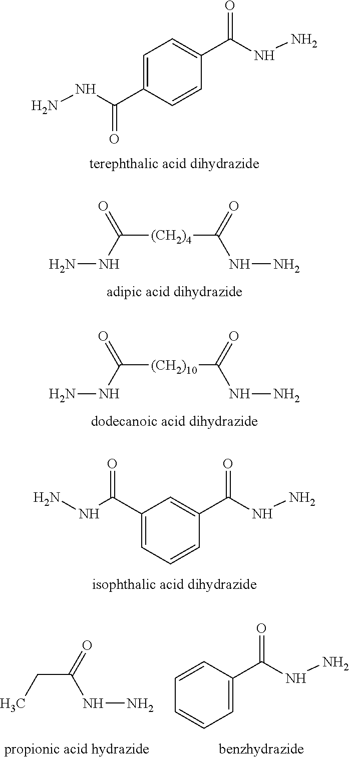

The method of incorporating the molecule is the following:

On an open mill, the rolls of which have a diameter equal to 150 mm, a nip equal to 2 mm and a rotational speed of the rolls of 20 rpm, the natural rubber undergoes the following stages:
1) 3 passes of natural rubber initially at ambient temperature;
2) addition of a given amount of dihydrazide in powder form;
3) carrying out 12 passes so as to disperse the powder and to homogenize the sample.

Two different types of natural rubber were tested in order to constitute the masterbatches, an NR referenced TSR20 and an NR referenced TSR3L.

The details are presented in the table below:

TABLE 1

| | | | Amount in | | | |
|---|---|---|---|---|---|---|
| Ref. | Type | Dihydrazide | phr | Stage 1 | Stage 2 | Stage 3 |
| A | TSR20 | | | | | |
| B | TSR20 | | | X | | X |
| G | TSR20 | Terephthalic | 1 | X | X | X |
| H | TSR20 | Adipic | 1 | X | X | X |
| I | TSR20 | Dodecanoic | 1 | X | X | X |
| J | TSR20 | Isophthalic | 1 | X | X | X |
| K | TSR3L | | | | | |
| M | TSR3L | Terephthalic | 1 | X | X | X |
| N | TSR3L | Adipic | 1 | X | X | X |
| Q | TSR20 | Propionic | 1 | X | X | X |
| R | TSR20 | Benzhydrazide | 1 | X | X | X |

The propionic and benzhydrazide molecules are counterexamples (aliphatic and benzoic monohydrazides).

In this example, the elastomers were used for the preparation of rubber compositions each comprising carbon black as reinforcing filler.

Each of these compositions has the following formulation (expressed in phr: parts per hundred parts of rubber (elastomer)).

TABLE 1a

| | Composition | | |
|---|---|---|---|
| | A, B, Q, R, M, | | Compositions |
| | N and G to K | Composition S | T and U |
| Diene elastomer (1) | 100 | 100 | 80 |
| Diene elastomer (2) | | | 20 |
| Filler (3) | 55 | 55 | 55 |
| Cobalt compound (4) | 1.5 | 1.5 | 1.5 |
| Antioxidant (5) | 1.5 | 1.5 | 1.5 |
| Stearic acid | 0.6 | 0.6 | 0.6 |
| ZnO | 8 | 8 | 8 |
| Methylene acceptor (6) | | 1 | |
| Methylene donor (7) | | 0.5 | |
| Sulphenamide (8) | 0.7 | 0.7 | 0.7 |
| Active sulphur | 4.5 | 4.5 | 4.5 |

(1) = Natural rubber TSR20 or TSR3L
(2) = SSBR with 26% of stirene and 24% of poly(1,2-butadiene) units
(3) = Black N330
(4) = Cobalt naphthenate
(5) = N-(1,3-dimethylbutyl)-N′-phenyl-p-phenylenediamine,
(6) = Resorcinol (Sumitomo)
(7) = HMT (hexamethylenetetraamine-Degussa)
(8) = TBBS

The diene elastomer (1) incorporated into compositions S and T is the elastomer A. The diene elastomer (1) incorporated into composition U is the elastomer G.

Each of the compositions is produced, in a first step, by thermomechanical working then, in a second finishing step, by mechanical working.

The elastomer, the carbon black, the antioxidant, the cobalt compound, the stearic acid, the zinc oxide and the methylene acceptor specific to the composition S are introduced successively into an internal mixer of “Banbury” type, the capacity of which is 3300 cm³ with a fill factor of 70% and with an initial temperature of around 50° C. This thermomechanical working stage is carried out for 3 to 5 minutes, up to a dropping temperature of the order of 170° C. approximately, with a mean speed of the blades of 60 rpm.

The mixture thus obtained is recovered, cooled, then, in an external mixer (homo-finisher), the following are added: the sulphur, the sulphanamide at 23° C., and the methylene donor specific to the composition S, the combined mixture being further mixed for a time of 3 to 4 minutes (second aforementioned step of mechanical working).

The compositions thus obtained are then calendered, either in the form of sheets (with a thickness ranging from 2 to 3 mm) or fine sheets of rubber, for the measurement of their physical or mechanical properties.

The compositions thus obtained may also be extruded in the form of profiled elements that can be used directly, after cutting and/or assembly to the desired dimensions, for example as semi-finished products for tires.

The compositions thus obtained may also be used to produce a metal/rubber composite for preparing adhesion test specimens as described in the measurements and tests section.

The crosslinking is carried out at 150° C. for 40 min.

The results are recorded in Table 1b below:

TABLE 1b

| Compositions | | | | | | | | |
|---|---|---|---|---|---|---|---|---|
| A | B | G | H | I | J | Q | R | S |

Properties in the non-crosslinked state

| | | | | | | | | | |
|---|---|---|---|---|---|---|---|---|---|
| ML 1 + 4 at 100° C. | 100 | 95 | 108 | 133 | 126 | 114 | 91 | 103 | 101 |
| (“Mooney compound”) | | | | | | | | | |

Properties in the crosslinked state

| | | | | | | | | | |
|---|---|---|---|---|---|---|---|---|---|
| Shore A | 100 | 102 | 101 | 100 | 102 | 102 | 111 | 105 | 108 |
| MA300/MA100 at 23° C. | 100 | 100 | 100 | 102 | 100 | 98 | 83 | 89 | 95 |

Dynamic properties as a function of the strain

| | | | | | | | | | |
|---|---|---|---|---|---|---|---|---|---|
| Delta G* at 60° C. | 100 | 104 | 82 | 68 | 76 | 92 | 187 | 107 | 128 |
| Tan (δ)ₘₐₓ at 60° C. | 100 | 102 | 80 | 72 | 70 | 82 | 112 | 93 | 96 |

Adhesion test

| | | | | | | | | | |
|---|---|---|---|---|---|---|---|---|---|
| Tear-out force (relative units) | 100 | 103 | 101 | 111 | 103 | 105 | 35 | 99 | 115 |
| Fa in the initial state | | | | | | | | | |

The compositions G, H, I and J, in accordance with the invention, have a Shore hardness and an MA300/MA100 reinforcement index at 23° C. which are equivalent to those of the control composition A. Furthermore, the tack of compositions G, H, I and J in accordance with the invention is maintained, or even improved relative to that of the control composition A. These properties of maintaining stiffness, cohesion and adhesion of compositions G, H, I and J in accordance with the invention are obtained with, in addition, a marked decrease in the values Delta G* at 60° C. and tan(δ)ₘₐₓ at 60° C. relative to those of the control composition A.

The stiffness-cohesion-adhesion-hysteresis compromise of the compositions based on elastomers in accordance with the invention is improved due to a markedly reduced hysteresis, for stiffness, cohesion and adhesion levels that are maintained relative to the reference composition. Compositions Q and R, not in accordance with the invention, display a higher Shore stiffness than the reference composition A and an MA300/MA100 reinforcement index of less than that of the reference composition A and/or values of Delta G* at 60° C. and/or tan(δ)ₘₐₓ at 60° C. that are higher then those of the reference composition A and/or a strength of adhesion to the reinforcement that is degraded relative to that of the reference composition. On the whole, the compositions Q and R containing a propionic acid hydrazide or a benzhydrazide do not make it possible to improve the stiffness-cohesion-adhesion-hysteresis compromise relative to the reference elastomer A.

The composition S comprising a methylene donor/acceptor system is known to a person skilled in the art as being a reference for the adhesive properties of compositions with reinforcements. It should then be noted that the good adhesive properties of composition S are obtained with an increase in the Shore hardness, a decrease in MA300/MA100 and little impact on the hysteresis. This reference composition S then provides a stiffness-cohesion-adhesion-hysteresis compromise that is not as good as, for example, composition H of the invention based on isophthalic acid dihydrazide modified elastomer mentioned previously in the text.

TABLE 1c

Compositions

| | |
|---|---|
| T | U |

Properties in the non-crosslinked state

| | | |
|---|---|---|
| ML 1 + 4 at 100° C. | 100 | 109 |
| (“Mooney compound”) | | |

Properties in the crosslinked state

| | | |
|---|---|---|
| Shore A | 100 | 99 |
| MA300/MA100 | 100 | 101 |

Dynamic properties as a function of the strain

| | | |
|---|---|---|
| Delta G* at 60° C. | 100 | 79 |
| Tan (δ)ₘₐₓ at 60° C. | 100 | 78 |

Adhesion test

| | | |
|---|---|---|
| Tear-out force (relative units) | 100 | 98 |
| Fa after wet heat ageing | | |

The composition U in accordance with the invention has a Shore hardness and an MA300/MA100 reinforcement index at 23° C. equivalent to that of the control composition T. Furthermore, the tack, even after accelerated (wet heat) ageing of the composition U in accordance with the invention is not degraded relative to that of the control composition T. This property of maintaining the stiffness, cohesion and adhesion of the composition U in accordance with the invention is obtained with, in addition, a marked decrease in the values of Delta G* at 60° C. and tan(δ)ₘₐₓ at 60° C. relative to those of the control composition T.

The stiffness-cohesion-adhesion-hysteresis compromise of the compositions based on elastomers in accordance with the invention is improved due to a markedly reduced hysteresis, for stiffness, cohesion and adhesion levels that are maintained relative to the reference composition.

TABLE 1d

| Compositions | | |
|---|---|---|
| K | M | N |

Properties in the non-crosslinked state

| | | | |
|---|---|---|---|
| ML 1 + 4 at 100° C. | 100 | 110 | 121 |
| (“Mooney compound”) | | | |

Properties in the crosslinked state

| | | | |
|---|---|---|---|
| Shore A | 100 | 99 | 101 |
| MA300/MA100 at 23° C. | 100 | 100 | 102 |

Dynamic properties as a function of the strain

| | | | |
|---|---|---|---|
| Delta G* at 60° C. | 100 | 62 | 65 |
| Tan (δ)ₘₐₓ at 60° C. | 100 | 74 | 67 |

Adhesion test

| | | | |
|---|---|---|---|
| Tear-out force (relative units) | 100 | 125 | 132 |
| Fa after heat ageing | | | |

The compositions M and N in accordance with the invention have a Shore hardness and an MA300/MA100 reinforcement index at 23° C. that are equivalent to those of the control composition K. Furthermore, the tack of compositions M and N in accordance with the invention is markedly improved, even after accelerated (heat) ageing, relative to that of the control composition K. These properties of maintaining the stiffness and cohesion, with improvement of the adhesion in the aged state, of compositions M and N in accordance with the invention are obtained with, in addition, a marked decrease in the values of Delta G* at 60° C. and tan(δ)ₘₐₓ at 60° C. relative to those of the control composition K.

The stiffness-cohesion-adhesion-hysteresis compromise of the compositions based on elastomers in accordance with the invention is improved due to a markedly reduced hysteresis, for stiffness, cohesion and adhesion levels that are maintained, or even improved, relative to the reference composition.

### EXAMPLE 2

### Effect of Sulphur Content

In this example, the molecule in accordance with the invention is of terephthalic acid dihydrazide nature and is introduced at 1 phr in accordance with the stages 1, 2 and 3 described in Example 1, into the compositions G, AF and AG.

TABLE 2a

| | Compositions | | |
|---|---|---|---|
| | A & G | AD & AF | AE & AG |
| Diene elastomer (1) | 100 | 100 | 100 |
| Filler (2) | 55 | 55 | 55 |
| Cobalt compound (3) | 1.5 | 1.5 | 1.5 |
| Antioxidant (4) | 1.5 | 1.5 | 1.5 |
| Stearic acid | 0.6 | 0.6 | 0.6 |
| ZnO | 8 | 8 | 8 |
| Sulphenamide (5) | 0.7 | 0.7 | 0.7 |
| Sulphur | 4.5 | 2.5 | 7.5 |

(1) = Natural rubber TSR20
(2) = Black N330
(3) = Cobalt naphthenate
(4) = N-(1,3-dimethylbutyl)-N′-phenyl-p-phenylenediamine
(5) = TBBS

Each of the compositions is produced, in a first step, by thermomechanical working then, in a second finishing step, by mechanical working.

The elastomer, the carbon black, the antioxidant, the cobalt compound, the stearic acid and the zinc oxide are introduced successively into an internal mixer of “Banbury” type, the capacity of which is 3300 cm³ with a fill factor of 70% and with an initial temperature of around 50° C. This thermomechanical working stage is carried out for 3 to 5 minutes, up to a maximum dropping temperature of the order of 170° C. approximately, with a mean speed of the blades of 60 rpm. The mixture thus obtained is recovered, cooled, then, in an external mixer (homo-finisher), the following are added: the sulphur, the sulphanamide at 23° C., the combined mixture being further mixed for a time of 3 to 4 minutes (second aforementioned step of mechanical working). The compositions thus obtained are then calendered, either in the form of sheets (with a thickness ranging from 2 to 3 mm) or fine sheets of rubber, for the measurement of their physical or mechanical properties.

The compositions thus obtained may also be extruded in the form of profiled elements that can be used directly, after cutting and/or assembly to the desired dimensions, for example as semi-finished products for tires.

The compositions thus obtained may also be used to produce a metal/rubber composite for preparing adhesion test specimens as described in the measurements and tests section.

The crosslinking is carried out at 150° C. for 40 min.

The results are recorded in Table 2b below:

TABLE 2b

| Compositions | | | | | |
|---|---|---|---|---|---|
| A | AD | AE | G | AF | AG |

Properties in the non-crosslinked state

| | | | | | | |
|---|---|---|---|---|---|---|
| ML 1 + 4 at 100° C. | 100 | 111 | 107 | 108 | 120 | 117 |
| (“Mooney compound”) | | | | | | |

Properties in the crosslinked state

| | | | | | | |
|---|---|---|---|---|---|---|
| Shore A | 100 | 97 | 104 | 101 | 96 | 105 |
| MA300/MA100 at 23° C. | 100 | 115 | 95 | 100 | 111 | 97 |

Dynamic properties as a function of the strain

| | | | | | | |
|---|---|---|---|---|---|---|
| Delta G* at 60° C. | 100 | 89 | 110 | 82 | 74 | 79 |
| Tan (δ)ₘₐₓ at 60° C. | 100 | 104 | 100 | 80 | 89 | 75 |

The reference materials A, AD and AE exhibit changes in the Shore stiffness and in the MA300/MA100 reinforcement index as a function of the sulphur content, in accordance with what is known by a person skilled in the art. These stiffness/reinforcement compromises are accompanied by hysteresis properties that are maintained or increased. The compositions G, AF and AG in accordance with the invention maintain the same tendencies of the changes of Shore hardness and of reinforcement index with the sulphur content. Nevertheless, the latter provide an improvement of hysteresis properties. The stiffness-cohesion-hysteresis compromise of the compositions G, AF and AG based on elastomers in accordance with the invention is improved due to a markedly reduced hysteresis, with stiffness and cohesion parameters, as a function of the sulphur content, that are unchanged.

### EXAMPLE 3

### Effect of the Presence of Cobalt Salt

In this example, the molecule in accordance with the invention is of terephthalic acid dihydrazide nature and is introduced at 1 phr in accordance with stages 1, 2 and 3 described in Example 1, into the compositions G, AM and AO.

The amounts added of the various cobalt salts are identical in terms of number of moles of cobalt.

TABLE 3a

| | Compositions | | |
|---|---|---|---|
| | A & G | AL & AM | AN & AO |
| Diene elastomer (1) | 100 | 100 | 100 |
| Filler (2) | 55 | 55 | 55 |
| Cobalt compound (3) | 1.5 | | |
| Cobalt compound (4) | | 1.9 | |
| Antioxidant (5) | 1.5 | 1.9 | 1.5 |
| Stearic acid | 0.6 | 1.5 | 0.6 |
| ZnO | 8 | 0.6 | 8 |
| Sulphenamide (6) | 0.7 | 8 | 0.7 |
| Sulphur | 4.5 | 0.7 | 4.5 |
| | | 4.5 | |

(1) = Natural rubber TSR20
(2) = Black N330
(3) = Cobalt naphthenate
(4) = Cobalt stearate
(5) = N-(1,3-dimethylbutyl)-N′-phenyl-p-phenylenediamine,
(6) = TBBS

Each of the compositions is produced, in a first step, by thermomechanical working then, in a second finishing step, by mechanical working.

The elastomer, the carbon black, the antioxidant, the cobalt compound, the stearic acid and the zinc oxide are introduced successively into an internal mixer of “Banbury” type, the capacity of which is 3300 cm³ with a fill factor of 70% and with an initial temperature of around 50° C. This thermomechanical working stage is carried out for 3 to 5 minutes, up to a maximum dropping temperature of the order of 170° C. approximately, with a mean speed of the blades of 60 rpm.

The mixture thus obtained is recovered, cooled, then, in an external mixer (homo-finisher), the following are added: the sulphur, the sulphanamide at 23° C., the combined mixture being further mixed for a time of 3 to 4 minutes (second aforementioned step of mechanical working).

The compositions thus obtained are then calendered, either in the form of sheets (with a thickness ranging from 2 to 3 mm) or fine sheets of rubber, for the measurement of their physical or mechanical properties.

The compositions thus obtained may also be extruded in the form of profiled elements that can be used directly, after cutting and/or assembly to the desired dimensions, for example as semi-finished products for tires.

The compositions thus obtained may also be used to produce a metal/rubber composite for preparing adhesion test specimens as described in the measurements and tests section.

The crosslinking is carried out at 150° C. for 40 min.

The results are recorded in Table 3b below:

TABLE 3b

| Compositions | | | | | |
|---|---|---|---|---|---|
| A | G | AL | AM | AN | AO |

Properties in the non-crosslinked state

| | | | | | | |
|---|---|---|---|---|---|---|
| ML 1 + 4 at 100° C. | 100 | 108 | 100 | 115 | 100 | 107 |
| (“Mooney compound”) | | | | | | |

Properties in the crosslinked state

| | | | | | | |
|---|---|---|---|---|---|---|
| Shore A | 100 | 101 | 100 | 98 | 100 | 99 |
| MA300/MA100 at 23° C. | 100 | 100 | 100 | 105 | 100 | 103 |

Dynamic properties as a function of the strain

| | | | | | | |
|---|---|---|---|---|---|---|
| Delta G* at 60° C. | 100 | 82 | 100 | 74 | 100 | 85 |
| Tan (δ)ₘₐₓ at 60° C. | 100 | 80 | 100 | 79 | 100 | 89 |

Adhesion test

| | | | | | | |
|---|---|---|---|---|---|---|
| Tear-out force (relative units) | 100 | 95 | 100 | 103 | 100 | 95 |
| Fa after wet heat ageing | | | | | | |

The compositions G, AM and AO in accordance with the invention have a Shore hardness and an MA300/MA100 reinforcement index at 23° C. which are equivalent to those of respective control compositions A, AL and AN. This maintenance of the stiffness and cohesion properties for the compositions in accordance with the invention is obtained with a decrease in the values of Delta G* at 60° C. and tan(δ)ₘₐₓ at 60° C. relative to those of the respective control compositions A, AL and AN. Furthermore, the tack, even after accelerated (wet heat) ageing of the compositions G, AM and AO in accordance with the invention is not degraded relative to that of respective control compositions A, AL and AN.

The stiffness-cohesion-hysteresis-adhesion compromise of the compositions based on elastomers in accordance with the invention is improved due to a markedly reduced hysteresis, for stiffness, cohesion and adhesion levels that are maintained. Moreover, it may be deduced from these results that this stiffness-cohesion-hysteresis-adhesion compromise is improved by the invention whether the adhesion promoter is present or not, and independently of the nature of this adhesion promoter.

### EXAMPLE 4

### Effect of Silica Minority

In this example, the molecule in accordance with the invention is of terephthalic acid dihydrazide nature and is introduced at 1 phr, in accordance with stages 1, 2 and 3 described in Example 1 of this document, into the compositions G, AR and AS.

TABLE 4a

| | Compositions | | |
|---|---|---|---|
| | A & G | AP & AR | AQ & AS |
| Diene elastomer (1) | 100 | 100 | 100 |
| Filler 1 (2) | 55 | 40 | 30 |
| Filler 2 (3) | | 15 | 26 |
| Silane (4) | | 1.2 | 2.1 |
| Cobalt compound (5) | 1.5 | 1.5 | 1.5 |
| Antioxidant (6) | 1.5 | 1.5 | 1.5 |
| Stearic acid | 0.6 | 0.6 | 0.6 |
| ZnO | 8 | 8 | 8 |
| Sulphenamide (7) | 0.7 | 0.7 | 0.7 |
| Sulphur | 4.5 | 4.5 | 4.5 |

(1) = Natural rubber TSR20
(2) = Black N330
(3) = Zeosil 160MP from Rhodia
(4) = Si69 from Degussa
(5) = Cobalt naphthenate
(6) = N-(1,3-dimethylbutyl)-N′-phenyl-p-phenylenediamine,
(7) = TBBS

Each of the compositions is produced, in a first step, by thermomechanical working then, in a second finishing step, by mechanical working.

The elastomer, the carbon black, the silica, the antioxidant, the cobalt compound, the stearic acid, the silane and the zinc oxide are introduced successively into an internal mixer of “Banbury” type, the capacity of which is 3300 cm³ with a fill factor of 70% and with an initial temperature of around 50° C. This thermomechanical working stage is carried out for 3 to 5 minutes, up to a maximum dropping temperature of the order of 170° C. approximately, with a mean speed of the blades of 60 rpm.

The mixture thus obtained is recovered, cooled, then, in an external mixer (homo-finisher), the following are added: the sulphur, the sulphanamide at 23° C., the combined mixture being further mixed for a time of 3 to 4 minutes (second aforementioned step of mechanical working).

The compositions thus obtained are then calendered, either in the form of sheets (with a thickness ranging from 2 to 3 mm) or fine sheets of rubber, for the measurement of their physical or mechanical properties.

The compositions thus obtained may also be extruded in the form of profiled elements that can be used directly, after cutting and/or assembly to the desired dimensions, for example as semi-finished products for tires.

The compositions thus obtained may also be used to produce a metal/rubber composite for preparing adhesion test specimens as described in the measurements and tests section.

The crosslinking is carried out at 150° C. for 40 min.

The results are recorded in Table 4b below:

TABLE 4b

| Compositions | | | | | |
|---|---|---|---|---|---|
| A | G | AP | AR | AQ | AS |

Properties in the non-crosslinked state

| | | | | | | |
|---|---|---|---|---|---|---|
| ML 1 + 4 at 100° C. | 100 | 108 | 100 | 132 | 100 | 143 |
| (“Mooney compound”) | | | | | | |

Properties in the crosslinked state

| | | | | | | |
|---|---|---|---|---|---|---|
| Shore A | 100 | 101 | 100 | 101 | 100 | 100 |
| MA300/MA100 at 23° C. | 100 | 100 | 100 | 101 | 100 | 107 |

Dynamic properties as a function of the strain

| | | | | | | |
|---|---|---|---|---|---|---|
| Delta G* at 60° C. | 100 | 82 | 100 | 100 | 100 | 85 |
| Tan (δ)ₘₐₓ at 60° C. | 100 | 80 | 100 | 87 | 100 | 85 |

Adhesion test

| | | | | | | |
|---|---|---|---|---|---|---|
| Tear-out force (relative units) | 100 | 101 | 100 | 104 | 100 | 98 |
| Fa in the initial state | | | | | | |
| Tear-out force (relative units) | 100 | 108 | 100 | 140 | nd* | nd* |
| Fa after heat ageing | | | | | | |

nd* = not determined

Compositions G, AR and AS in accordance with the invention have a Shore hardness and an MA300/MA100 reinforcement index at 23° C. that are equivalent to or improved relative to those of the respective control compositions A, AP and AQ. These properties of maintaining the stiffness and cohesion, in accordance with the invention, are obtained with a reduction in the values of tan(δ)ₘₐₓ at 60° C. relative to those of the respective control compositions A, AP and AQ. The stiffness-cohesion-hysteresis-adhesion compromise of compositions G, AR and AS, based on elastomers in accordance with the invention, is improved due to a markedly reduced hysteresis, for stiffness, cohesion and adhesion levels that are maintained. Under accelerated ageing tests the adhesion is also maintained, or even improved.

### EXAMPLE 5

### Effect of the Method of Introduction

In this example, for composition G, the molecule in accordance with the invention is of terephthalic acid dihydrazide nature and is introduced at 1 phr in accordance with stages 1, 2 and 3 described in Example 1 of this document.

For the composition AT, the molecule in accordance with the invention is of terephthalic acid dihydrazide nature and is introduced at 1 phr into the internal mixer during the thermomechanical working stage.

TABLE 5a

Compositions

| | A | G and AT |
|---|---|---|
| Diene elastomer (1) | 100 | 100 |
| Hydrazide compound (2) | | 1 |
| Filler (3) | 55 | 55 |
| Cobalt compound (4) | 1.5 | 1.5 |
| Antioxidant (5) | 1.5 | 1.5 |
| Stearic acid | 0.6 | 0.6 |
| ZnO | 8 | 8 |
| Sulphenamide (6) | 0.7 | 0.7 |
| Sulphur | 4.5 | 4.5 |

(1) = Natural rubber TSR20
(2) = Terephthalic acid dihydrazide
(3) = Black N330
(4) = Cobalt naphthenate
(5) = N-(1,3-dimethylbutyl)-N′-phenyl-p-phenylenediamine,
(6) = TBBS

Each of the compositions is produced, in a first step, by thermomechanical working then, in a second finishing step, by mechanical working.

The elastomer, the carbon black, the antioxidant, the cobalt compound, the stearic acid, the zinc oxide and the hydrazide compounds specific to the composition AT are introduced successively into an internal mixer of “Banbury” type, the capacity of which is 3300 cm³ with a fill factor of 70% and with an initial temperature of around 50° C. This thermomechanical working stage is carried out for 3 to 5 minutes, up to a maximum dropping temperature of the order of 170° C. approximately, with a mean speed of the blades of 60 rpm.

The mixture thus obtained is recovered, cooled, then, in an external mixer (homo-finisher), the following are added: the sulphur, the sulphanamide at 23° C., the combined mixture being further mixed for a time of 3 to 4 minutes (second aforementioned step of mechanical working).

The compositions thus obtained are then calendered, either in the form of sheets (with a thickness ranging from 2 to 3 mm) or fine sheets of rubber, for the measurement of their physical or mechanical properties.

The compositions thus obtained may also be extruded in the form of profiled elements that can be used directly, after cutting and/or assembly to the desired dimensions, for example as semi-finished products for tires.

The compositions thus obtained may also be used to produce a metal/rubber composite for preparing adhesion test specimens as described in the measurements and tests section.

The crosslinking is carried out at 150° C. for 40 min.

The results are recorded in Table 5b below:

TABLE 5b

| Compositions | | |
|---|---|---|
| A | G | AT |

Properties in the non-crosslinked state

| | | | |
|---|---|---|---|
| ML 1 + 4 at 100° C. | 100 | 108 | 120 |
| (“Mooney compound”) | | | |

Properties in the crosslinked state

| | | | |
|---|---|---|---|
| Shore A | 100 | 101 | 100 |
| MA300/MA100 at 23° C. | 100 | 100 | 102 |

Dynamic properties as a function of the strain

| | | | |
|---|---|---|---|
| Delta G* at 60° C. | 100 | 82 | 72 |
| Tan (δ)ₘₐₓ at 60° C. | 100 | 80 | 75 |

Adhesion test

| | | | |
|---|---|---|---|
| Tear-out force (relative units) | 100 | 101 | 98 |
| Fa in the initial state | | | |
| Tear-out force (relative units) | 100 | 108 | 113 |
| Fa after heat ageing | | | |

The compositions G and AT, in accordance with the invention, have a Shore hardness and an MA300/MA100 reinforcement index at 23° C. which are equivalent to those of the control composition A. Furthermore, the tack of compositions G and AT in accordance with the invention is maintained, or even improved relative to that of the control composition A. These properties of maintaining stiffness, cohesion and adhesion of compositions G and AT in accordance with the invention are obtained with, in addition, a marked decrease in the values Delta G* at 60° C. and tan(δ)ₘₐₓ at 60° C. relative to those of the control composition A.

The stiffness-cohesion-adhesion-hysteresis compromise of the compositions based on elastomers in accordance with the invention is improved due to a markedly reduced hysteresis, for stiffness, cohesion and adhesion levels that are maintained relative to the reference composition.

1. A tire component which is not in contact with air or with an inflation gas, comprising a rubber composition comprising (a) an elastomeric matrix based on natural rubber, (b) a reinforcing filler, (c) from more than 2.5 to 8.5 phr of sulphur and (d) a dihydrazide compound corresponding to the following formula: 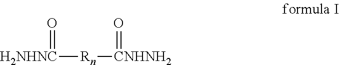
in which R is a divalent hydrocarbon radical chosen from substituted or unsubstituted aromatic radicals having 6 to 20 carbon atoms, linear or branched, saturated or unsaturated, aliphatic radicals having 2 to 20 carbon atoms, and n is equal to 0 or 1.

2. The tire component according to claim 1, comprising a thread-like reinforcing element.

3. The tire component according to claim 2, wherein the thread-like reinforcing element is made of steel.

4. The tire component according to claim 3, wherein said component is chosen from the carcass ply and the crown plies.

5. The tire component according to claim 1, wherein said component is a layer adjacent to a reinforcement/rubber composite.

6. The tire component according to claim 1, wherein the dihydrazide compound is chosen from phthalic acid dihydrazide, isophthalic acid dihydrazide, terephthalic acid dihydrazide, succinic acid dihydrazide, adipic acid dihydrazide, azelaic acid dihydrazide, sebacic acid dihydrazide, oxalic acid dihydrazide and dodecanoic acid dihydrazide.

7. The tire component according to claim 1, wherein the natural rubber is present in the elastomeric matrix in a predominant weight fraction.

8. The tire component according to claim 1, wherein the elastomeric matrix comprises between 0 and 50% by weight, of the total weight of the matrix, of another diene elastomer.

9. The tire component according to claim 1, wherein the elastomeric matrix comprises 100% by weight of natural rubber.

10. The tire component according to claim 1, wherein the reinforcing filler comprises more than 50% by weight, of the total weight of the filler, of a reinforcing organic filler.

11. The tire component according to claim 10, wherein the reinforcing organic filler is carbon black.

12. The tire component according to claim 1, wherein sulphur is present in the composition in a proportion ranging from 3.5 to 7 phr.

13. The tire component according to claim 1, wherein the composition comprises an adhesion promoter.

14. The tire component according to claim 13, wherein the adhesion promoter contained in the composition is a cobalt-based compound.

15. A process for preparing a tire component as described in claim 1, comprising the steps of:
(i) carrying out, at a maximum temperature of between 130° C. and 200° C., a first step of thermomechanical working of the necessary base constituents of the rubber composition, with the exception of the crosslinking system, by intimate incorporation, by kneading, into the elastomeric matrix based on natural rubber, of ingredients of the composition, then
(ii) carrying out, at a temperature below said maximum temperature of said first step, preferably below 120° C., a second step of mechanical working during which said crosslinking system is incorporated,
(iii) extrusion or calendering of the rubber composition thus obtained, in the desired form, in order to manufacture the tire component,
wherein, prior to carrying out the aforementioned stage (i), the process comprises the stages of manufacturing natural rubber comprising a stage of adding the dihydrazide compound of formula I.

16. A process for preparing a tire component as described in claim 1, comprising the steps of:
(i) carrying out, at a maximum temperature of between 130° C. and 200° C., a first step of thermomechanical working of the necessary base constituents of the rubber composition, with the exception of the crosslinking system, by intimate incorporation, by kneading, into the elastomeric matrix based on natural rubber, of ingredients of the composition, then
(ii) carrying out, at a temperature below said maximum temperature of said first step, preferably below 120° C., a second step of mechanical working during which said crosslinking system is incorporated,
(iii) extrusion or calendering of the rubber composition thus obtained, in the desired form, in order to manufacture the tire component,
wherein, prior to carrying out the aforementioned stage (i), the process comprises a stage of preparing a masterbatch based on natural rubber and on the dihydrazide compound of formula I.

17. A process for preparing a tire component as described in claim 1, comprising the steps of:
(i) carrying out, at a maximum temperature of between 130° C. and 200° C., a first step of thermomechanical working of the necessary base constituents of the rubber composition, with the exception of the crosslinking system, by intimate incorporation, by kneading, into the elastomeric matrix based on natural rubber, of ingredients of the composition, then
(ii) carrying out, at a temperature below said maximum temperature of said first step, preferably below 120° C., a second step of mechanical working during which said crosslinking system is incorporated,
(iii) extrusion or calendering of the rubber composition thus obtained, in the desired form, in order to manufacture the tire component,
wherein the dihydrazide compound of formula I is added to the mixture during stage (i).

18. The process according to any one of claims 15 to 17, wherein an adhesion promoter is incorporated into the elastomeric matrix during stage (i).

19. The process according to any one of claims 15 to 17, wherein an adhesion promoter is incorporated into the mixture resulting from stage (i), during stage (ii).

20. A tire, wherein at least one of its components not in contact with air or with an inflation gas is a component as described in claim 1.

21. The tire according to claim 20, wherein the component is a composite comprising metallic thread-like reinforcing elements chosen from the carcass ply or the crown plies.

22. The tire according to claim 20, wherein the component is a layer adjacent to a reinforcement/rubber composite.
